(19) United States
(12) Patent Application Publication
(10) Pub. No.: US 2007/0177097 A1
(43) Pub. Date: Aug. 2, 2007

(54) Spectacles and sunshade-clip assembly

(76) Inventors: Suk-Jae Lee, Daegu (KR); Ju-Jae Lee, Daegu (KR); Hyun-Jun Lee, Daegu (KR); Sung-Jun Lee, Daegu (KR)

Correspondence Address: ST. ONGE STEWARD JOHNSTON & REENS, LLC, 986 BEDFORD STREET, STAMFORD, CT, 06905-5619, US

(21) Appl. No.: 11/343,473

(22) Filed: Jan. 31, 2006

(51) Int. Cl. G02C 9/00

(52) U.S. Cl. 351/47

(57) ABSTRACT

Disclosed herein is a spectacles and sunshade-clip assembly in which a sunshade-clip is adapted to be detachably attached to spectacles by use of spectacles magnets and clip magnets. The spectacles include a pair of metallic circular lens frames each having separated portions for the insertion of each prescription lens, a pair of temple arms, and a pair of hinge legs each fixed to one of the lens frames to hingedly connect the lens frame to one of the temple arms. A pair of upper and lower fixing pieces protrudes outward from the separated portions of each lens frame perpendicular thereto, to be connected to each other. The sunshade-clip includes a pair of clip lens frames as optional elements. One of the spectacles magnet is provided in a coupling location of the pair of upper and lower fixing pieces to be positioned behind one of the hinge legs.

### FIELD OF THE INVENTION

The present invention relates to a spectacles and sunshade-clip assembly, and, more particularly, to an improved configuration to detachably attach a sunshade-clip to spectacles by use of magnets.

### BACKGROUND OF THE INVENTION

In conjunction with spectacles having a pair of prescription lenses and a sunshade-clip having a pair of colored clip lenses corresponding to the spectacles, an inventor of the present invention aims to achieve an improved configuration to detachably attach the sunshade-clip to the spectacles by means of a plurality of corresponding magnets.

Although there may be proposed various configurations of a spectacles and sunshade-clip assembly using magnets, practically, such a spectacles and sunshade-clip assembly has not been widely used in spite of availability thereof.

A main reason of a failure in commercialization of the spectacles and sunshade-clip assembly using magnets is a complexity in structure thereof. To realize a detachable attachment of a sunshade-clip to spectacles using magnets, generally, one or more pairs of magnets must be mounted to the sunshade-clip and the spectacles by use of separate magnet mounting members, which are referred to as magnet holders or magnet arms. Due to the magnet holders or magnet arms protruding from both the spectacles and the sunshade-clip, the overall structure of the spectacles and sunshade-clip assembly is complicated, resulting in an increased production price and unseemly outer appearance.

In particular, since the magnet arms of the spectacles are generally formed at hinge units that are used to connect lens frames to temple arms, a spectacles magnet must be mounted adjacent to a fastening piece provided at separated portions of each lens frame that receives a prescription lens therein, or must be mounted at a front location of each hinge unit. This complicated structure makes it difficult for manufacturers to fabricate the spectacles and sunshade-clip assembly. Furthermore, due to a large number of such attachment members protruding from the spectacles and the sunshade-clip, outer appearance of the assembly is greatly deteriorated, causing a decrease in marketability.

### SUMMARY OF THE INVENTION

Therefore, the present invention has been made in view of the above problems, and it is an object of the present invention to provide a spectacles and sunshade-clip assembly capable of utilizing existing spectacles parts to the maximum extent, thereby achieving a simplicity not only in manufacture but also in maintenance and repair, and improving outer appearance and coupling force thereof.

### BRIEF DESCRIPTION OF THE DRAWINGS

The above and other objects, features and other advantages of the present invention will be more clearly understood from the following detailed description taken in conjunction with the accompanying drawings, in which:

FIG. 1A is a rear perspective view illustrating a spectacles and sunshade-clip assembly according to a first embodiment of the present invention, prior to being worn, in particular, the circle B illustrating important parts in partially enlarged sectional view;

FIG. 1B is a sectional view of the circle A shown in FIG. 1;

FIG. 1C is a sectional view illustrating an alternative embodiment of the circle A of FIG. 1;

FIG. 1D is a sectional view illustrating another alternative embodiment of the circle A of FIG. 1;

FIG. 2 is a rear perspective view illustrating a spectacles and sunshade-clip assembly according to a second embodiment of the present invention, in particular, the circle C illustrating important parts in partially enlarged sectional view;

FIG. 3A is a perspective view illustrating a spectacles and sunshade-clip assembly according to a third embodiment of the present invention, prior to being worn;

FIG. 3B is a perspective view of the spectacles and sunshade-clip assembly of FIG. 3A in a worn state;

FIG. 4A is a perspective view illustrating an alternative embodiment of the spectacles and sunshade-clip assembly of FIG. 3A, prior to being worn; and

FIG. 4B is a perspective view of the spectacles and sunshade-clip assembly of FIG. 4A in a worn state.

### DETAILED DESCRIPTION OF THE INVENTION

Now, preferred embodiments of the present invention will be explained with reference to the accompanying drawings.

In the following description, left and right sides of a nose bridge, which connects a pair of lenses of spectacles or a sunshade-clip to each other, are symmetrical, and thus, only one side will be designated by reference numerals and explained.

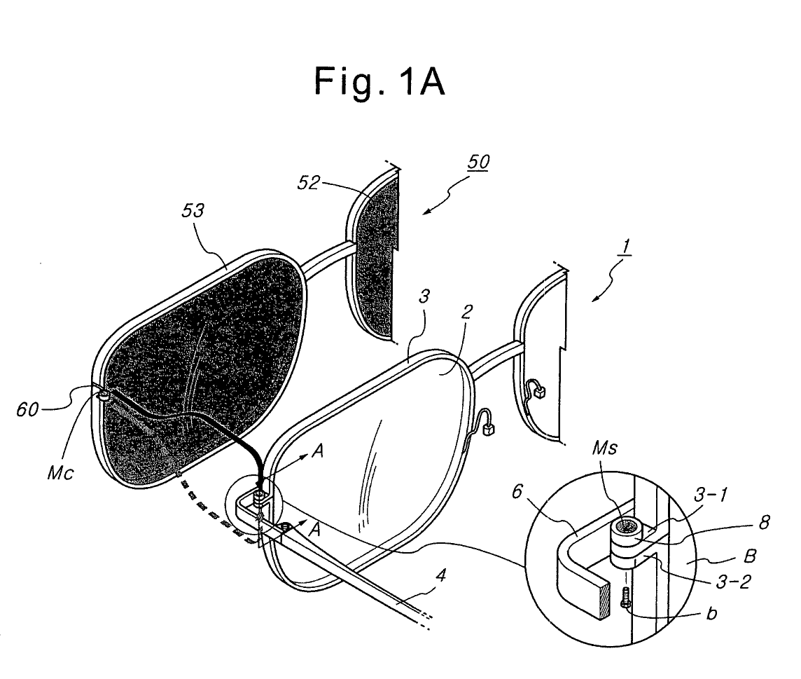

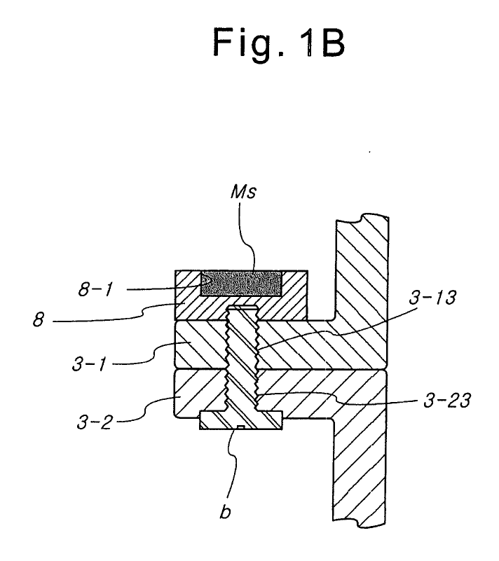

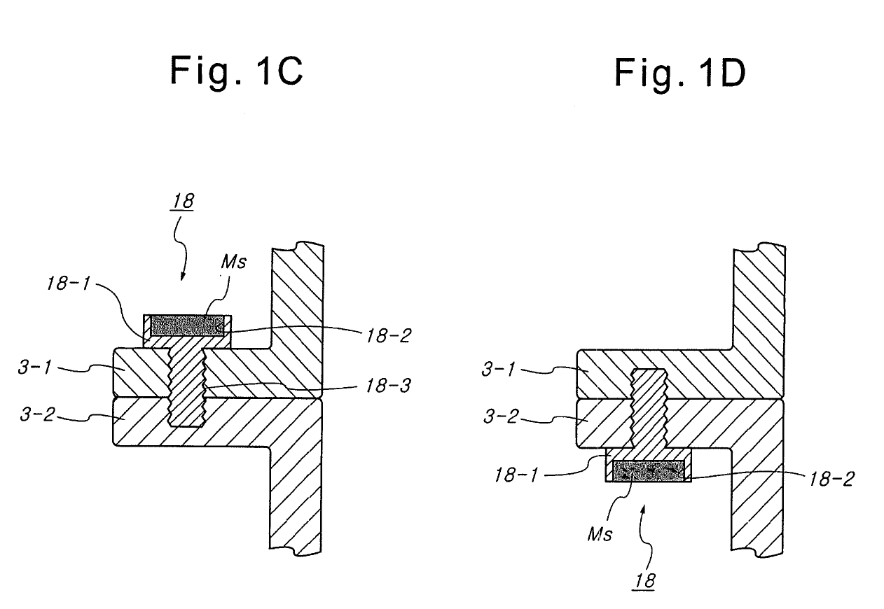

FIGS. 1A and 1B illustrate a spectacles and sunshade-clip assembly according to a first embodiment of the present invention, and FIGS. 1C and 1D illustrate alternative embodiments of FIG. 1B.

The present embodiment is based on a conventional configuration wherein a sunshade-clip 50 is detachably attached to spectacles 1 by use of magnets. Now, in addition to the basic configuration, other additional configurations will be explained.

As shown, the spectacles 1 include a pair of metallic lens frames 3 each having a prescription lens 2 fitted therein, a pair of temple arms 4, and a pair of hinge units to connect the lens frames 3 to the temple arms 4, respectively. Also, based on a conventional configuration, each of the hinge units includes a hinge leg 6 having one end hingedly connected to one of the temple arms 4 by use of a hinge shaft portion and the other end welded to one of the lens frames 3.

Each of the lens frame 3 is generally configured such that an approximately circular frame is separated into two portions at an outer lateral location thereof for the insertion of one of the prescription lenses 2. A pair of upper and lower fixing pieces 3-1 and 3-2 protrudes outward from the separated portions of the lens frame 3 perpendicular thereto, respectively. The upper and lower fixing pieces 3-1 and 3-2 are connected to each other by fastening a bolt b through bolt holes (not shown) perforated therethrough.

According to an important technical idea of the present embodiment, the upper and lower fixing pieces 3-1 and 3-2 and the bolt b constitute a magnet holder to receive a spectacles magnet. This eliminates a necessity of a separate arm member for the installation of a magnet, thereby achieving a reduction in the number of parts and an improved outer appearance of the spectacles and sunshade-clip assembly.

Referring to FIG. 1B, the magnet holder is illustrated in sectional view. As shown in FIG. 1B, a magnet nut 8 is provided to be fastened with the bolt b so as to couple the upper and lower fixing pieces 3-1 and 3-2 to each other. The magnet nut 8 has a magnet receiving recess 8-1 formed therein for the insertion of a spectacles magnet Ms. Preferably, the upper and lower fixing pieces 3-1 and 3-2 are formed at inner circumferential surfaces thereof with screw threads 3-13 and 3-23, respectively, to allow the bolt b to be penetrated and screwed through the lower fixing piece 3-2 and the upper fixing piece 3-1 in this sequence.

With this configuration, it is unnecessary to use a separate fastening piece for the installation of the spectacles magnet Ms, differently from the prior art. Such a simplified bolt and nut fastening structure of the present embodiment is sufficient to firmly fix the upper and lower fixing pieces 3-1 and 3-2 relative to each other and to integrally provide the lens frame 3 of the spectacles 1 with the spectacles magnet Ms.

Referring to FIG. 1C, an alternative embodiment of the magnet holder is illustrated in sectional view. In the alternative embodiment, a magnet bolt 18 is screwed through the lower and upper fixing pieces 3-2 and 3-1 in this sequence by use of screw threads 18-3 formed at an outer circumference thereof. The magnet bolt 18 has a magnet receiving recess 18-2 formed in a head portion 18-1 thereof, so that the spectacles magnet Ms is located at the top of the upper fixing piece 3-1.

Referring to FIG. 1D, another alternative embodiment of the magnet holder is illustrated in sectional view. Differently from FIG. 1C, the magnet bolt 18 is screwed through the upper and lower fixing pieces 3-1 and 3-2 in this sequence, so that the spectacles magnet Ms is located at the bottom of the lower fixing piece 3-2.

The above-described alternative embodiments as shown in FIGS.1C and 1D show that a clip magnet Mc, which is mounted in one of clip arms 60 of the sunshade clip 50 as will be described hereinafter, can access the spectacles magnet Ms from upper or lower sides thereof.

The head portion 18-1 of the magnet bolt 18 has an angled form to facilitate the fastening of the magnet bolt 18 using hand tools.

In summary, with the use of the magnet bolt 18, the upper and lower fixing pieces 3-1 and 3-2 are fastened to each other, and the spectacles magnet Ms is mounted at the top of the upper fixing piece 3-1 or at the bottom of the lower fixing piece 3-2.

Considering the sunshade-clip 50 to be attached to the spectacles 1, it includes a pair of clip lens frames 53 each receiving a colored clip lens 52 therein, but the lens frames 53 are not essential elements. That is, a pair of the clip arms 60 may be directly fixed at opposite outer ends of a pair of the colored clip lens 52 or a pair of the clip lens frames 53, respectively, to extend rearward. A pair of the clip magnets Mc is inserted into the pair of clip arms 60, respectively, to engage with the spectacles magnets Ms.

With the above-described configuration, the clip magnets Mc of the sunshade-clip 50 are detachably attached to the spectacles magnets Ms mounted at opposite outer ends of the spectacles 1. In an attached state thereof, both the spectacles magnets Ms and the clip magnets Mc are hidden by the hinge legs 6, resulting in an improved outer appearance by virtue of an elimination of additional magnet mounting members.

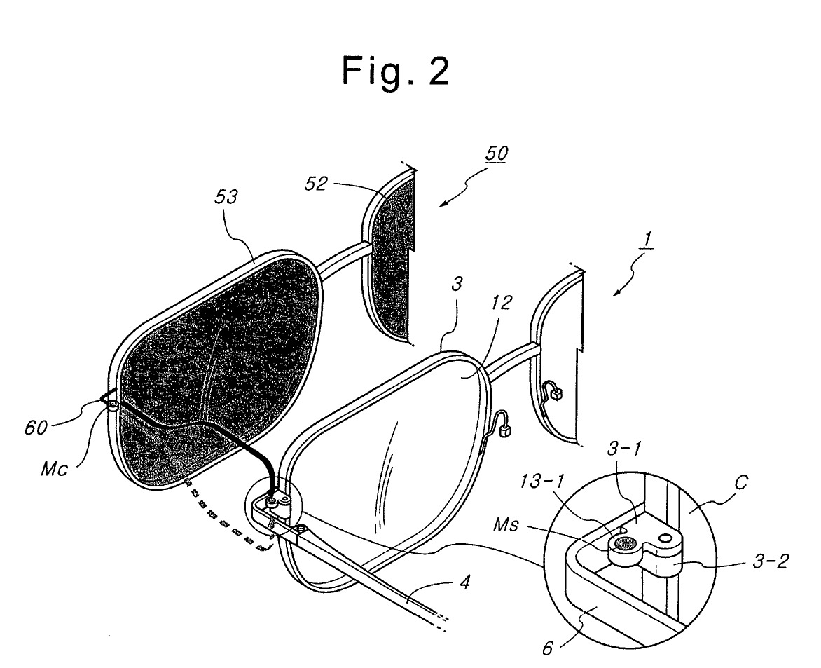

Referring to FIG. 2, a spectacles and sunshade-clip assembly according to a second embodiment of the present invention is illustrated in rear perspective view. In the present embodiment, the upper fixing piece 3-1 is integrally formed at a lateral location thereof with an upper extension 13-1. The spectacles magnet Ms is inserted in the upper extension 13-1. As will be easily understood from FIG. 2, the shape of the upper fixing piece 3-1 is variable in various manners.

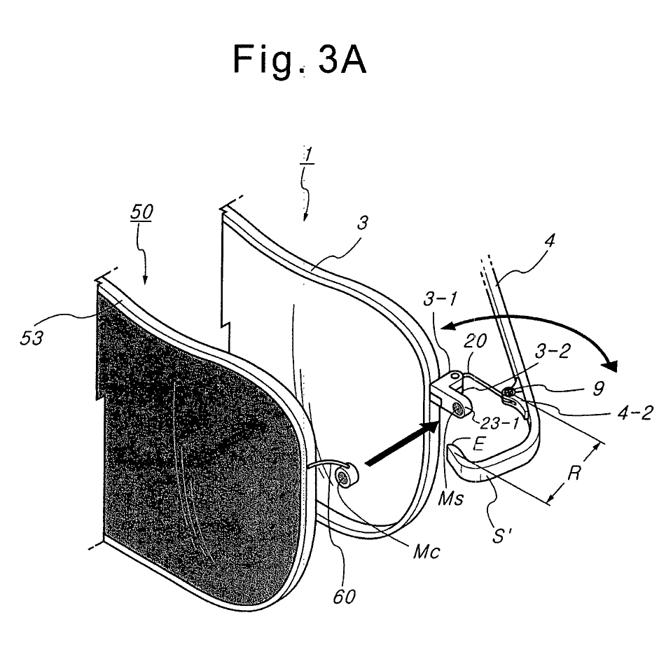

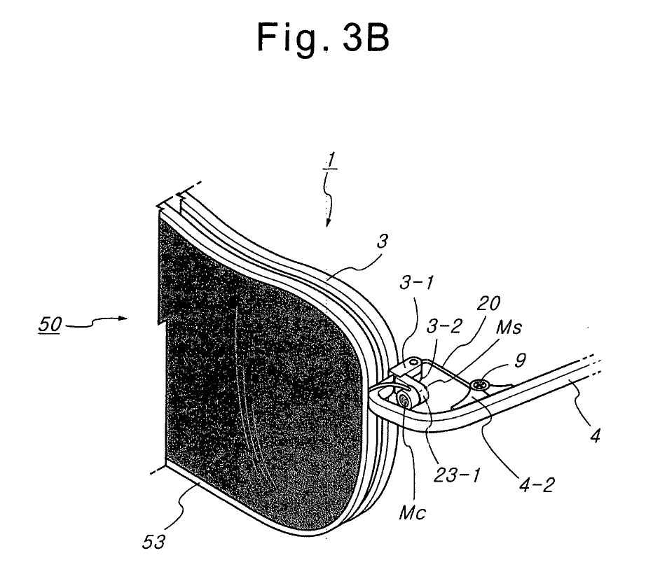

FIGS. 3A and 3B are perspective views illustrating a spectacles and sunshade-clip assembly according to a third embodiment of the present invention. In the present embodiment, one of the upper and lower fixing pieces 3-1 and 3-2 is deformed to have a laterally-extending portion 23-1. The spectacles magnet Ms is mounted at a front location of the laterally extending portion 23-1.

A linear hinge arm 20 is fixed at one end thereof to a rear location of the deformed upper or lower fixing piece 3-1 or 3-2. The other end of the hinge arm 20 is hingedly connected to a hinge shaft portion 4-2, which is formed at an end of the temple arm 4, by means of a bolt 9 fastened through a shaft hole (not designated by a reference numeral) of the hinge shaft portion 4-2. Thereby, the temple arm 4 is pivotally rotatable about the hinge arm 20.

A shield arm S is provided at the end of the temple arm 4 to extend forward from the hinge shaft portion 4-2. The shield arm S is inwardly bent toward the assembled upper and lower fixing pieces 3-1 and 3-2.

With this configuration, an end of the shield arm S is pivotally rotatable about the bolt 9 of the hinge shaft portion 4-2 by a turning radius R. Thereby, the shield arm S serves to hide the spectacles magnet Ms when it is rotated to come into contact with the upper and lower fixing pieces 3-1 and 3-2.

The configuration of the sunshade-clip 50 is identical to that of the previous embodiments.

In use, in a state wherein the temple arm 4 is pivotally folded toward the lens frame 3 and the shield arm S is spaced apart from the lens frame 3 to expose the spectacles magnet Ms forward, the clip magnet Mc, mounted in the clip arm 60, is attached to the spectacles magnet Ms mounted in the front location of the laterally extending portion 23-1 of the spectacles 1 as shown in FIG. 3A. Then, after the clip magnet Mc is completely attached to the spectacles magnet Ms, the temple arm 4 is pivotally unfolded from the lens frame 3, so that an end E of the shield arm S comes into contact with a front location of the assembled upper and lower fixing pieces 3-1 and 3-2. In such an unfolded state of the temple arm 4, the spectacles magnet Ms and the clip magnet Mc are located on the inside of the shield arm S to be hidden. Thus, it is difficult to detect the presence of the magnets Ms and Mc from the outside when the spectacles and sunshade-clip assembly is worn by a wearer, resulting in an improvement in outer appearance.

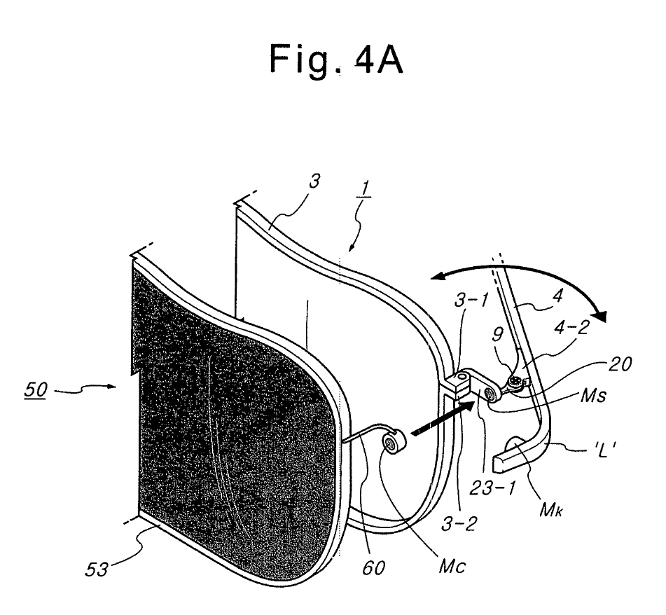

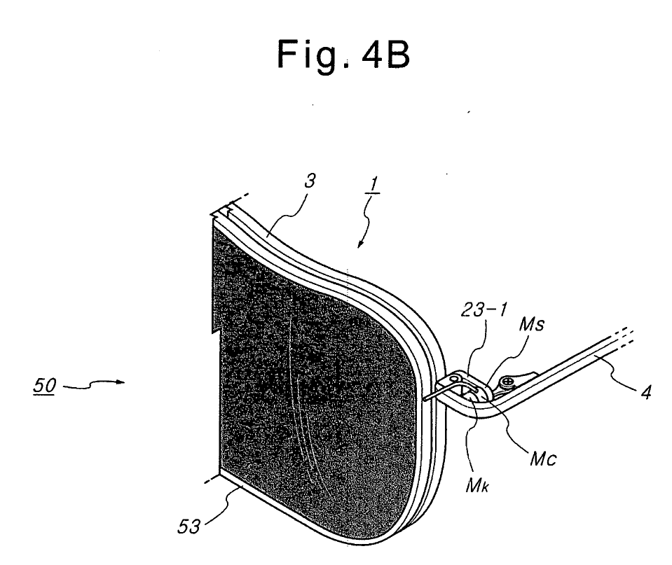

FIGS. 4A and 4B are perspective views illustrating an alternative embodiment of the spectacles and sunshade-clip assembly of FIGS. 3A and 3B.

In the present embodiment, a locking magnet Mk is mounted at an inner surface of the shield arm S at a position close to the end E of the shield arm S, so that the locking magnet Mk is attached to the clip magnet Mc mounted in the clip arm 60 of the sunshade-clip 50 after the clip magnet Mc is attached to the spectacles magnet Ms. Thereby, the shield arm also serves as a locking arm L.

With the present embodiment having the above described configuration, in a state wherein the temple arm 4 of the spectacles 1 is folded as shown in FIG. 4A, the clip magnet Mc mounted in the clip arm 60 of the sunshade-clip 50 is attached to the spectacles magnet Ms mounted in the laterally extending portion 23-1 of the upper or lower fixing piece 3-1 or 3-2 provided at the spectacles 1. After that, if the temple arm 4 is unfolded as shown in FIG. 4B, the locking magnet Mk is attached to a front location of the clip magnet Mc, thereby acting to press the clip magnet Mc rearward. As a result, the locking magnet Mk locks the clip magnet Mc and the spectacles magnet Ms, which are attached to each other, thereby achieving an increase in an attachment force of the sunshade-clip 50 relative to the spectacles 1.

Although the above-described embodiments describe that the pair of the spectacles magnet Ms and the clip magnet Mc is fixed to the spectacles 1 and the sunshade-clip 50 to correspond to each other, it should be understood that one of the spectacles 1 and the sunshade-clip 50 may be provided with magnets, and the other one may be provided with various magnetic members attracted by the magnets. This has the effect of more simplifying the overall structure of the spectacles and sunshade-clip assembly.

As is apparent from the above description, the present invention provides a spectacles and sunshade-clip assembly capable of ensuring easy attachment/detachment between spectacles and a sunshade-clip while achieving an improved outer appearance. Also, according to the present invention, it is possible to achieve not only an improved magnet arrangement to firmly attach the sunshade-clip to the spectacles, but also locking means to increase an attachment force of the sunshade-clip relative to the spectacles. Thus, the spectacles and sunshade-clip assembly of the present invention is convenient, in particular, for use in outdoor activities such as sports.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A spectacles and sunshade-clip assembly comprising:
spectacles including a pair of prescription lenses, a pair of metallic circular lens frames each having separated portions for the insertion of each prescription lens, a pair of temple arms, and a pair of hinge legs each fixed to one of the lens frames to hingedly connect the lens frame to one of the temple arms, a pair of upper and lower fixing pieces protruding outward from the separated portions of each lens frame perpendicular thereto, to be connected to each other; and
a sunshade-clip including a pair of colored clip lenses and a pair of clip lens frames as optional elements, the sunshade-clip being adapted to be detachably attached to the spectacles by use of magnets,
wherein a spectacles magnet is provided in a coupling location of the pair of upper and lower fixing pieces to be positioned behind one of the hinge legs, and
wherein the sunshade-clip further includes a pair of clip arms fixed at opposite outer ends of the colored clip lenses or the clop lens frames to extend rearward, and a clip magnet is provided in a respective one of the clip arms to be detachably attached to the spectacles magnet.

2. The assembly as set forth in claim 1, wherein the spectacles magnet, which is provided in the coupling location of the pair of upper and lower fixing pieces behind one of the hinge legs, is fixedly inserted into a magnet receiving recess formed in a magnet nut, and a bolt is screwed through the pair of upper and lower fixing pieces and the magnet nut.

3. The assembly as set forth in claim 1, wherein the spectacles magnet is fixedly inserted into a magnet receiving recess formed in a head portion of a magnet bolt, and the magnet bolt is screwed through the upper and lower fixing pieces by use of screw threads formed at an outer circumference thereof.

4. The assembly as set forth in claim 1, wherein the upper fixing piece of the spectacles is integrally formed at a lateral location thereof with an upper extension, and the spectacles magnet is inserted into the upper extension.

5. The assembly as set forth in claim 1, wherein: the upper fixing piece or lower fixing piece is deformed to have a laterally extending portion, and the spectacles magnet is mounted at a front location of the laterally extending portion;
a hinge arm is fixed at a rear location of the upper fixing piece or lower fixing piece; and
a free end of the hinge arm is hingedly connected to a hinge shaft portion that is formed at an end of one of the temple arms, and a locking magnet is mounted in an inwardly bent portion that is provided at the end of the temple arm to extend forward from the hinge shaft portion,
whereby the inwardly bent portion is pivotally rotated about the hinge shaft portion by a predetermined turning radius, so that the locking magnet provided at the bent portion of the temple arm presses and locks the clip magnet and the spectacles magnet, which are attached to each other.
